(19) United States
(12) Patent Application Publication
(10) Pub. No.: US 2015/0309652 A1
(43) Pub. Date: Oct. 29, 2015

(54) PORTABLE TERMINAL DEVICE AND INPUT CONTROL METHOD

(71) Applicant: FUJITSU LIMITED, Kawasaki-shi (JP)

(72) Inventor: KEIICHI KOZUTA, Kawasaki (JP)

(21) Appl. No.: 14/657,538

(22) Filed: Mar. 13, 2015

(30) Foreign Application Priority Data
Apr. 24, 2014 (JP) 2014-090038

(51) Int. Cl. G06F 3/041

(52) U.S. Cl. CPC G06F 3/0416

(57) ABSTRACT

A portable terminal device includes a touch panel configured to detect a touch operation by an operator, a memory, and a processor coupled to the memory, configured to determine a holding mode of the portable terminal device by the operator, and set a delay region, in which confirmation of the touch operation is delayed, in a predetermined region corresponding to the holding mode determined by the determination within an operation region of the touch panel.

### CROSS-REFERENCE TO RELATED APPLICATION

This application is based upon and claims the benefit of priority of the prior Japanese Patent Application No. 2014-090038, filed on Apr. 24, 2014, the entire contents of which are incorporated herein by reference.

### FIELD

The embodiment discussed herein is related to a portable terminal device and an input control method.

### BACKGROUND

In recent years, portable terminal devices have been in widespread use, such as a smartphone with a touch panel to receive a touch operation by an operator. The operator of the portable terminal device with the touch panel performs various touch operations by touching an operation region of the touch panel. However, when the operator performs a touch operation, while holding the portable terminal device in one hand, on the touch panel with a finger of the holding hand, the base of the finger unintentionally touches a part of the operation region of the touch panel, depending on a holding mode of the portable terminal device, which may lead to an erroneous operation. Therefore, various technologies to reduce such erroneous operations have been proposed.

For example, there is a technology to set an invalidation region to invalidate a touch operation in a part of an operation region of a touch panel, with which the operator is likely to accidentally come into contact, according to a holding mode of the portable terminal device by the operator. Such conventional technologies are disclosed in Japanese Laid-open Patent Publication No. 06-67788 and Japanese Laid-open Patent Publication No. 2011-28603, for example.

### SUMMARY

According to an aspect of the invention, a portable terminal device includes a touch panel configured to detect a touch operation by an operator, a memory, and a processor coupled to the memory, configured to determine a holding mode of the portable terminal device by the operator, and set a delay region, in which confirmation of the touch operation is delayed, in a predetermined region corresponding to the holding mode determined by the determination within an operation region of the touch panel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is an explanatory diagram (Part 1) illustrating an example of a delay region setting operation by the portable terminal device according to the embodiment;

FIG. 1B is an explanatory diagram (Part 2) illustrating an example of the delay region setting operation by the portable terminal device according to the embodiment;

FIG. 1C is an explanatory diagram (Part 1) illustrating an example of a touch operation after the delay region is set by the portable terminal device according to the embodiment;

FIG. 1D is an explanatory diagram (Part 2) illustrating an example of the touch operation after the delay region is set by the portable terminal device according to the embodiment;

FIG. 2 is a block diagram illustrating a configuration example of the portable terminal device according to the embodiment;

FIG. 3 is an explanatory diagram illustrating an example of a functional configuration of a CPU according to the embodiment;

FIG. 4A is an explanatory diagram (Part 1) illustrating an example of a processing operation by a touch operation control unit according to the embodiment;

FIG. 4B is an explanatory diagram (Part 2) illustrating an example of a processing operation by the touch operation control unit according to the embodiment;

FIG. 4C is an explanatory diagram (Part 3) illustrating an example of a processing operation by the touch operation control unit according to the embodiment;

FIG. 5 is a flowchart illustrating an example of procedures of delay region setting processing by the portable terminal device according to the embodiment;

FIG. 6 is a flowchart illustrating an example of procedures of touch operation control processing by the portable terminal device according to the embodiment; and

FIG. 7 is an explanatory diagram illustrating an electronic device configured to execute input control programs.

### DESCRIPTION OF EMBODIMENT

The conventional technology described above may reduce erroneous operations on a predetermined region of the touch panel, but has a problem that it is difficult to receive desired touch operations.

In the conventional technology described above, for example, when an invalidation region is set in a predetermined region of the touch panel, no touch operations may be received on the invalidation region. Therefore, when icons, buttons and the like that an operator wishes to touch are located in the invalidation region, there is a possibility that desired touch operations corresponding to the icons, buttons and the like are not executed.

The disclosed technology has been made in view of the above, and provides a portable terminal device, an input control method and an input control program, capable of receiving desired touch operations while reducing erroneous operations on a predetermined region of a touch panel.

Hereinafter, with reference to the drawings, detailed description is given of an embodiment of a portable terminal device, an input control method, and an input control program disclosed in the present application.

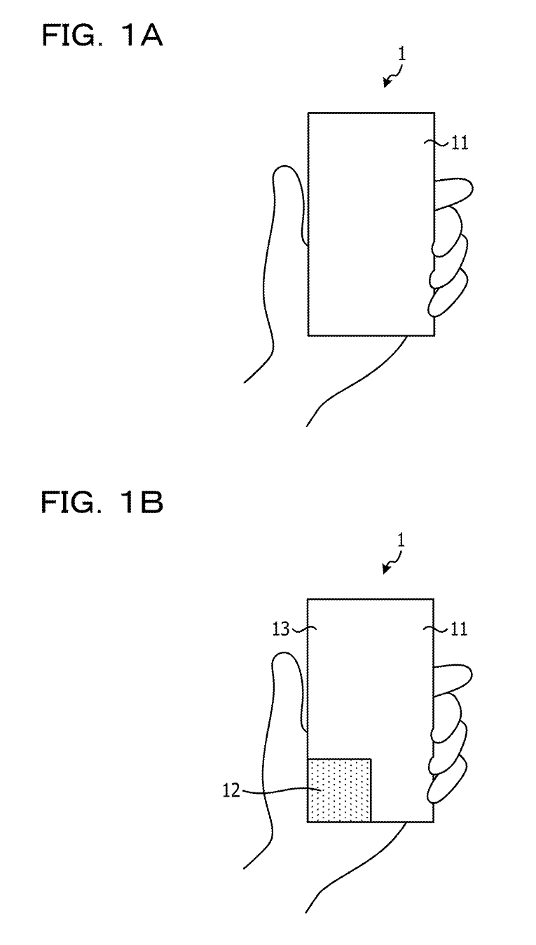

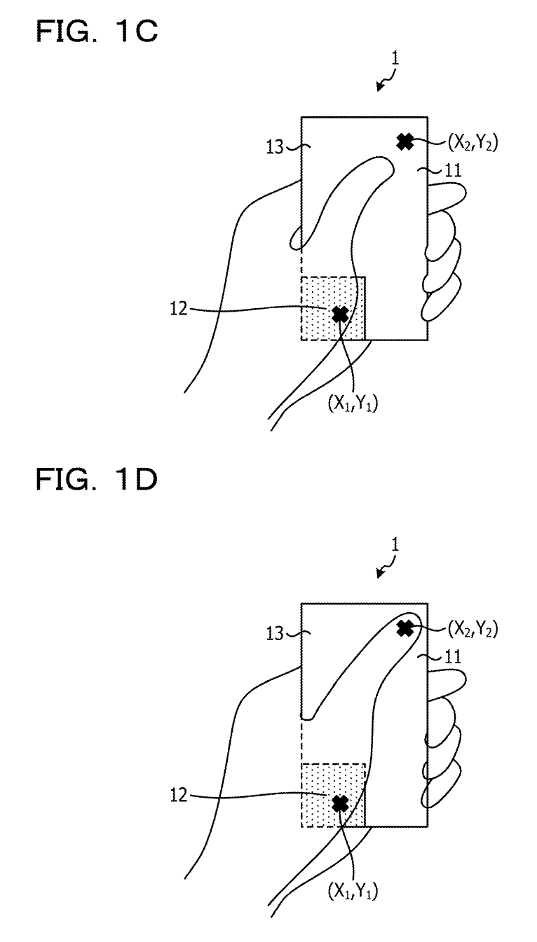

First, description is given of an example of operations by a portable terminal device 1 according to an embodiment. FIG. 1A is an explanatory diagram (Part 1) illustrating an example of a delay region setting operation by the portable terminal device according to the embodiment. In the example of FIG. 1A, it is assumed that an operator of the portable terminal device 1 is holding the portable terminal device 1 in his/her left hand. It is also assumed that the portable terminal device 1 has a touch panel that receives a touch operation by the operator. The portable terminal device 1 illustrated in FIG. 1A displays an operation region 11 of the touch panel on a display screen of a display when the portable terminal device 1 is turned ON or when a sleep mode of the portable terminal device 1 is released, for example. Although not illustrated in FIG. 1A, various app screens and buttons are disposed in the operation region 11. When the operation region 11 is displayed, the portable terminal device 1 determines a holding mode of the portable terminal device 1 by the operator. To be more specific, the portable terminal device 1 determines whether the operator is holding the portable terminal device 1 in his/her left hand or right hand.

FIG. 1B is an explanatory diagram (Part 2) illustrating an example of the delay region setting operation by the portable terminal device according to the embodiment. After having determined the holding mode of the portable terminal device 1, the portable terminal device 1 sets a delay region 12, in which confirmation of a touch operation is delayed, in a predetermined region corresponding to the determined holding mode of the portable terminal device 1 within the operation region 11 of the touch panel, as illustrated in FIG. 1B. The predetermined region corresponding to the holding mode of the portable terminal device 1 is a part of the operation region 11 of the touch panel, with which the base of a finger of the operator accidentally comes into contact, during a one-handed operation. For example, when the operator holds the portable terminal device 1 with his/her left hand, the predetermined region may be a region located at the lower-left corner of the operation region 11. On the other hand, when the operator holds the portable terminal device 1 with his/her right hand, the predetermined region may be a region located at the lower-right corner of the operation region 11. In the example of FIG. 1B, the hand of the operator holding the portable terminal device 1 is determined to be the left hand. Therefore, the portable terminal device 1 sets the predetermined region located at the lower-left corner of the operation region 11 as the delay region 12. Note that a region other than the delay region 12 within the operation region 11 of the touch panel is hereinafter called a normal region 13.

FIG. 1C is an explanatory diagram (Part 1) illustrating an example of a touch operation after the delay region is set by the portable terminal device according to the embodiment. The operator of the portable terminal device 1 performs a touch operation on the operation region 11 of the touch panel by touching coordinates (X₂, Y₂) on the operation region 11 with his/her finger as illustrated in FIG. 1C. Here, it is assumed that the base of the finger of the operator unintentionally touches coordinates (X₁, Y₁) on the operation region 11 before the finger touches the coordinates (X₂, Y₂) on the operation region 11.

FIG. 1D is an explanatory diagram (Part 2) illustrating an example of the touch operation after the delay region is set by the portable terminal device according to the embodiment. Upon receipt of the touch operation, the portable terminal device 1 detects coordinates (hereinafter referred to as the “touch coordinates”) of a contact position on the operation region 11 of the touch panel. When the detected touch coordinates are located in the delay region 12, the portable terminal device 1 waits for a predetermined time before confirming the touch operation using the touch coordinates. Then, after the elapse of the predetermined time, the portable terminal device 1 confirms the touch operation using the touch coordinates. Meanwhile, when other touch coordinates (hereinafter referred to as “new touch coordinates”) to be newly detected before the predetermined time passes are located in the normal region 13, the portable terminal device 1 confirms a touch operation using the new touch coordinates. In the example of FIG. 1D, since the coordinates (X₁, Y₁), which are the touch coordinates, are located in the delay region 12, the portable terminal device 1 waits for the predetermined time before confirming a touch operation using the coordinates (X₁, Y₁). On the other hand, since the coordinates (X₂, Y₂), which are the new touch coordinates detected before the predetermined time passes, are located in the normal region 13, the portable terminal device 1 confirms a touch operation using the coordinates (X₂, Y₂).

As described above, the portable terminal device 1 according to the embodiment determines its own holding mode by the operator, and sets the predetermined region corresponding to the determined holding mode within the operation region 11 of the touch panel as the delay region 12 in which the confirmation of the touch operation is delayed. Thus, the portable terminal device 1 according to the embodiment may quickly confirm a new touch operation on a region other than the delay region 12 while waiting for a touch operation on the delay region 12 to be confirmed. As a result, an erroneous operation on the delay region 12 of the touch panel can be reduced. Moreover, the portable terminal device 1 according to the embodiment extends the time before the touch operation is confirmed rather than invalidating the touch operation on the delay region 12. Thus, the portable terminal device 1 may also receive a desired touch operation on the delay region 12. In other words, the portable terminal device 1 according to the embodiment may receive desired touch operations while reducing erroneous operations on the predetermined region of the touch panel.

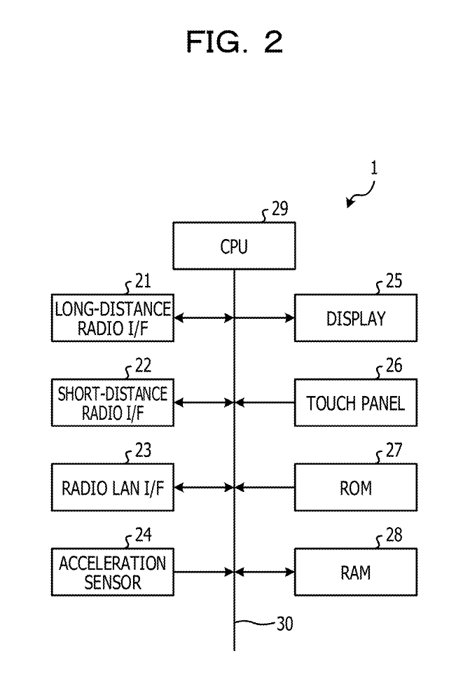

Next, description is given of a configuration example of the portable terminal device 1 according to the embodiment. FIG. 2 is a block diagram illustrating the configuration example of the portable terminal device according to the embodiment. The portable terminal device 1 illustrated in FIG. 2 is a portable telephone terminal, such as a smartphone, with a touch panel function to receive a touch operation by the operator, for example. The portable terminal device 1 includes a long-distance radio interface (I/F) 21, a short-distance radio I/F 22, a radio local area network (LAN) I/F 23, and an acceleration sensor 24. The portable terminal device 1 also includes a display 25, a touch panel 26, a read only memory (ROM) 27, and a random access memory (RAM) 28. The portable terminal device 1 further includes a central processor unit (CPU) 29 and a bus 30.

The long-distance radio I/F 21 is an interface that controls a long-distance radio communication function. The short-distance radio I/F 22 is an interface that controls a short-distance radio communication function. The radio LAN I/F 23 is an interface that controls a radio LAN function. The acceleration sensor 24 is a sensor configured to detect accelerations of the portable terminal device 1 itself on three axes, x-axis, y-axis, and z-axis, for example. The display 25 is a liquid crystal display (LCD) or the like, configured to display various kinds of information on a screen. The touch panel 26 is a touch panel configured to receive a touch operation on an operation region of the touch panel 26 displayed on the display 25.

The ROM 27 is a storage device configured to store various programs such as an input control program, for example. The RAM 28 is a storage device configured to store various kinds of information. The CPU 29 is a control device configured to control the entire portable terminal device 1. The bus 30 connects various devices, such as the CPU 29 and the RAM 28 in the portable terminal device 1, to each other.

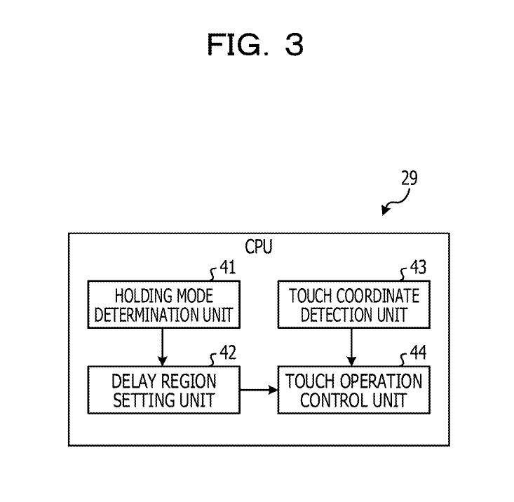

Here, an example of a functional configuration of the CPU 29 is described. FIG. 3 is an explanatory diagram illustrating an example of the functional configuration of the CPU according to the embodiment. Note that the CPU 29 reads an input control program stored in the ROM 27 and configures various processes as functions based on the read input control program. The CPU 29 illustrated in FIG. 3 includes a holding mode determination unit 41, a delay region setting unit 42, a touch coordinate detection unit 43, and a touch operation control unit 44.

The holding mode determination unit 41 determines a holding mode of the portable terminal device 1 by an operator. For example, the holding mode determination unit 41 uses acceleration waveforms in the left and right directions of the portable terminal device 1, which are detected by the acceleration sensor 24, to determine whether the hand holding the portable terminal device 1 is the left hand or right hand. Also, the holding mode determination unit 41 determines the holding mode of the portable terminal device 1 when the portable terminal device 1 is turned ON or when a sleep mode of the portable terminal device 1 is released, for example. The holding mode determination unit 41 is an example of a determination unit.

The delay region setting unit 42 sets a delay region 12, in which confirmation of a touch operation by the operator is delayed, in a predetermined region corresponding to the holding mode of the portable terminal device 1 within the operation region 11 of the touch panel 26. The predetermined region to be set as the delay region 12 may be a part of the operation region 11 of the touch panel, with which the base of a finger of the operator is likely to accidentally come into contact, during a one-handed operation. For example, when it is determined by the holding mode determination unit 41 that the portable terminal device 1 is held in the left hand, the delay region setting unit 42 sets a lower left region located at the lower-left corner of the operation region 11 of the touch panel 26 as the delay region 12. On the other hand, when it is determined by the holding mode determination unit 41 that the portable terminal device 1 is held in the right hand, the delay region setting unit 42 sets a lower right region located at the lower-right corner of the operation region 11 of the touch panel 26 as the delay region 12. The delay region setting unit 42 is an example of a setting unit.

The touch coordinate detection unit 43 detects touch coordinates when a touch operation by the operator is received. Then, the touch coordinate detection unit 43 outputs the detected touch coordinates to the touch operation control unit 44.

When the touch coordinates detected by the touch coordinate detection unit 43 are located in the delay region 12, the touch operation control unit 44 waits for a predetermined time t before confirming the touch operation using the touch coordinates. Then, after the elapse of the predetermined time t, the touch operation control unit 44 confirms the touch operation using the touch coordinates. Confirmation of the touch operation means to output the detected touch coordinates to a higher-level processing unit that performs predetermined application processing using the touch coordinates, for example. In other words, when the touch coordinates detected by the touch coordinate detection unit 43 are located in the delay region 12, the touch operation control unit 44 delays execution of the predetermined application processing by delaying the output of the touch coordinates to the higher-level processing unit.

On the other hand, when the touch coordinates detected by the touch coordinate detection unit 43 are located in the normal region 13, the touch operation control unit 44 confirms the touch operation using the touch coordinates.

Meanwhile, when other touch coordinates (hereinafter “new touch coordinates”) are newly detected by the touch coordinate detection unit 43 before the predetermined time t passes after the detection of the touch coordinates by the touch coordinate detection unit 43, the touch operation control unit 44 performs the following processing. Specifically, when the new touch coordinates are located in the normal region 13, the touch operation control unit 44 confirms a touch operation using the new touch coordinates. On the other hand, when the new touch coordinates are located in the delay region 12, the touch operation control unit 44 waits for the predetermined time t before confirming the touch operation using the new touch coordinates.

Moreover, when no more touch coordinates are detected before the predetermined time t passes after the detection of the touch coordinates by the touch coordinate detection unit 43, the touch operation control unit 44 invalidates the touch operation using the touch coordinates. In other words, when no more touch coordinates are detected before the predetermined time t passes after the detection of the touch coordinates by the touch coordinate detection unit 43, the touch operation control unit 44 stops execution of a predetermined application by stopping the output of the touch coordinates to the higher-level processing unit.

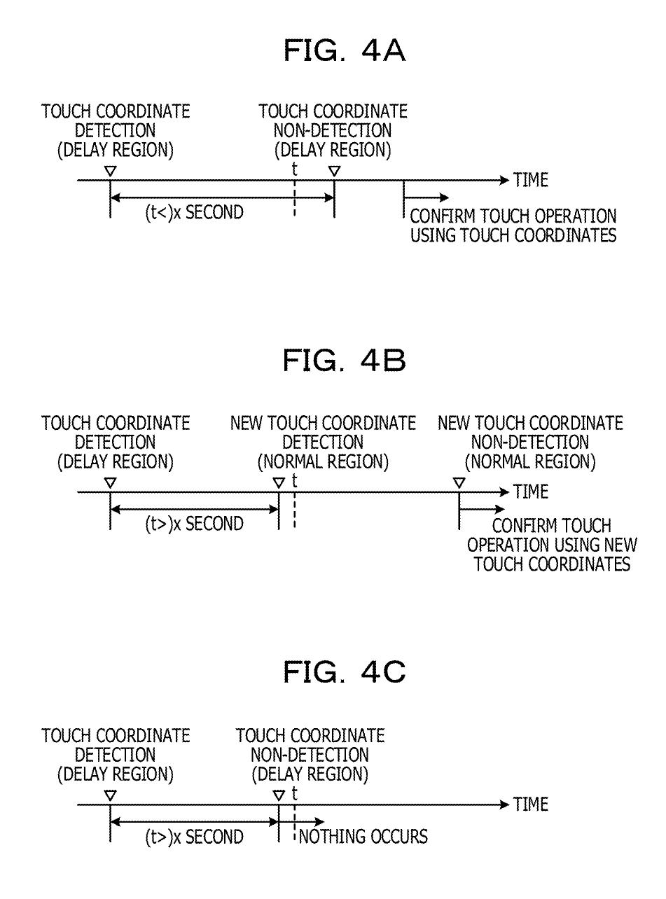

Here, description is given of an example of a processing operation by the touch operation control unit 44. FIG. 4A is an explanatory diagram (Part 1) illustrating an example of the processing operation by the touch operation control unit according to the embodiment. FIG. 4A illustrates a case where touch coordinates detected by the touch coordinate detection unit 43 are located in the delay region 12 and no more touch coordinates are detected in x seconds after the predetermined time t has passed since the detection of the touch coordinates. In this case, the touch operation control unit 44 confirms the touch operation using the touch coordinates since the predetermined time t has passed.

FIG. 4B is an explanatory diagram (Part 2) illustrating an example of a processing operation by the touch operation control unit according to the embodiment. FIG. 4B illustrates a case where touch coordinates detected by the touch coordinate detection unit 43 are located in the delay region 12, new touch coordinates are detected in x seconds before the predetermined time t passes after the detection of the touch coordinates, and the new touch coordinates are located in the normal region 13. In this case, the touch operation control unit 44 confirms the touch operation using the touch coordinates when no more new touch coordinates are detected.

FIG. 4C is an explanatory diagram (Part 3) illustrating an example of a processing operation by the touch operation control unit according to the embodiment. FIG. 4C illustrates a case where touch coordinates detected by the touch coordinate detection unit 43 are located in the delay region 12 and no more touch coordinates are detected in x seconds before the predetermined time t passes after the detection of the touch coordinates. In this case, the touch operation control unit 44 invalidates the touch operation using the touch coordinates.

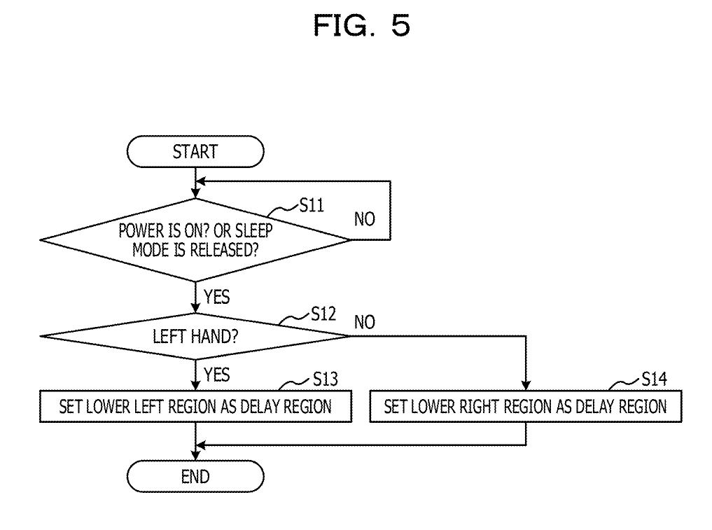

Next, description is given of an example of processing procedures by the portable terminal device 1 according to the embodiment. FIG. 5 is a flowchart illustrating an example of procedures of delay region setting processing by the portable terminal device according to the embodiment.

In FIG. 5, when the portable terminal device 1 is turned OFF or a sleep mode of the portable terminal device 1 is maintained (Step S11; No), the holding mode determination unit 41 in the CPU 29 stands by. On the other hand, when the portable terminal device 1 is turned ON or the sleep mode of the portable terminal device 1 is released (Step S11; Yes), the holding mode determination unit 41 determines whether or not the hand holding the portable terminal device 1 is the left hand (Step S12).

When it is determined that the hand holding the portable terminal device 1 is the left hand (Step S12; Yes), the delay region setting unit 42 in the CPU 29 sets a lower left region located at the lower-left corner of the operation region 11 of the touch panel 26 as the delay region 12 (Step S13).

On the other hand, when it is determined that the hand holding the portable terminal device 1 is the right hand (Step S12; No), the delay region setting unit 42 sets a lower right region located at the lower-right corner of the operation region 11 of the touch panel 26 as the delay region 12 (Step S14).

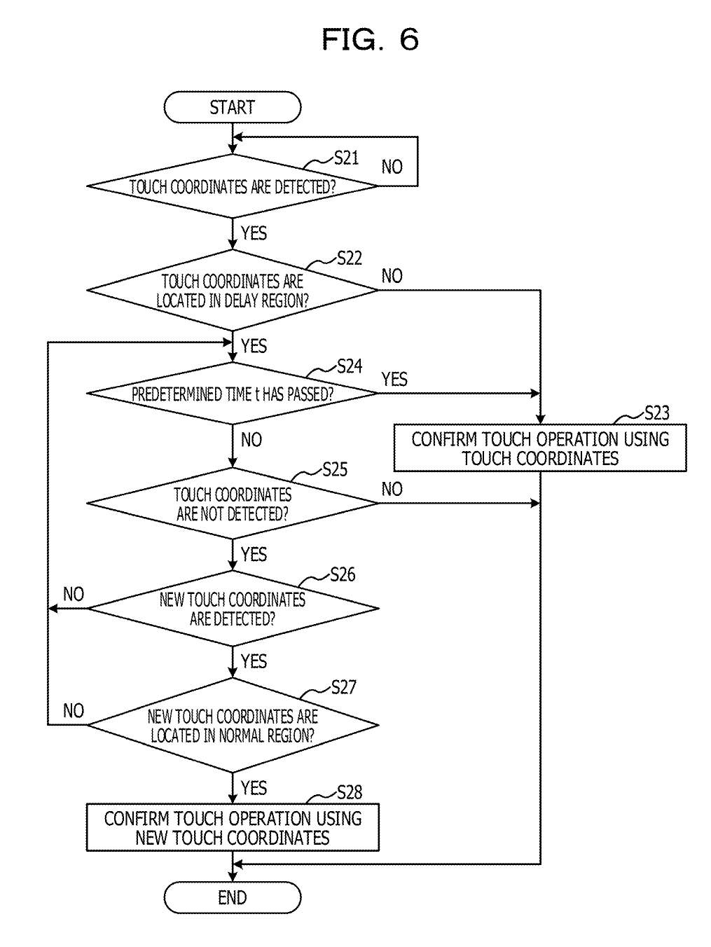

FIG. 6 is a flowchart illustrating an example of procedures of touch operation control processing by the portable terminal device according to the embodiment. The touch operation control processing illustrated in FIG. 6 is processing of controlling confirmation of a touch operation when the touch operation is performed after the delay region 12 is set.

In FIG. 6, when no touch coordinates are detected by the touch coordinate detection unit 43 (Step S21; No), the touch operation control unit 44 in the CPU 29 stands by. On the other hand, when touch coordinates are detected by the touch coordinate detection unit 43 (Step S21; Yes), the touch operation control unit 44 determines whether or not the detected touch coordinates are located in the delay region 12 (Step S22).

When the detected touch coordinates are located in the normal region 13 (Step S22; No), the touch operation control unit 44 confirms the touch operation using the touch coordinates (Step S23).

On the other hand, when the detected touch coordinates are located in the delay region 12 (Step S22; Yes), the touch operation control unit 44 waits for a predetermined time t before confirming the touch operation using the touch coordinates. In other words, the touch operation control unit 44 determines whether or not the predetermined time t has passed since the detection of the touch coordinates by the touch coordinate detection unit 43, without confirming the touch operation using the touch coordinates (Step S24).

When the predetermined time t has passed (Step S24; Yes), the touch operation control unit 44 moves the processing to Step S23 to confirm the touch operation using the touch coordinates when no more touch coordinates are detected.

On the other hand, when the predetermined time t has not passed (Step S24; No), the touch operation control unit 44 determines whether or not touch coordinates are continuously detected (Step S25). When no more touch coordinates are detected (Step S25; Yes), the touch operation control unit 44 terminates the processing to invalidate the touch operation using the touch coordinates.

On the other hand, when the touch coordinates are continuously detected (Step S25; No), the touch operation control unit 44 determines whether or not new touch coordinates are detected by the touch coordinate detection unit 43 (Step S26).

When no new touch coordinates are detected (Step S26; No), the touch operation control unit 44 returns the processing to Step S24.

On the other hand, when new touch coordinates are detected (Step S26; Yes), the touch operation control unit 44 determines whether or not the new touch coordinates are located in the normal region 13 (Step S27).

When the new touch coordinates are located in the delay region 12 (Step S27; No), the touch operation control unit 44 returns the processing to Step S24 to hold the confirmation of a touch operation using the new touch coordinates until the predetermined time t passes.

On the other hand, when the new touch coordinates are located in the normal region 13 (Step S27; Yes), the touch operation control unit 44 confirms the touch operation using the new touch coordinates when no more new touch coordinates are detected (Step S28), and then terminates the processing.

As described above, the portable terminal device 1 according to the embodiment determines its own holding mode by the operator, and sets the predetermined region corresponding to the determined holding mode within the operation region 11 of the touch panel as the delay region 12 in which the confirmation of the touch operation is delayed. Thus, the portable terminal device 1 according to the embodiment may quickly confirm a new touch operation on a region other than the delay region 12 while waiting for a touch operation on the delay region 12 to be confirmed. As a result, an erroneous operation on the delay region 12 of the touch panel can be reduced. Moreover, the portable terminal device 1 according to the embodiment extends the time before the touch operation is confirmed rather than invalidating the touch operation on the delay region 12. Thus, the portable terminal device 1 may also receive a desired touch operation on the delay region 12. As a result, the portable terminal device 1 according to the embodiment may receive desired touch operations while reducing erroneous operations on the predetermined region of the touch panel.

Moreover, the portable terminal device 1 according to the embodiment sets the delay region 12 in the lower left region within the operation region 11 when the device is determined to be held in the left hand, and sets the delay region 12 in the lower right region within the operation region 11 when the device is determined to be held in the right hand. As a result, the portable terminal device 1 according to the embodiment may set the delay region 12 in a part of the operation region 11 of the touch panel 26, with which the base of a finger of the operator is likely to accidentally come into contact, during a one-handed operation. Thus, erroneous operations may be more effectively reduced.

Moreover, when touch coordinates to be detected are located in the delay region 12, the portable terminal device 1 according to the embodiment waits for the predetermined time t before confirming the touch operation using the touch coordinates. Then, after the elapse of the predetermined time t, the portable terminal device 1 confirms the touch operation using the touch coordinates. As a result, even if the base of the finger of the operator or the like accidentally touches the delay region 12, the portable terminal device 1 according to the embodiment may hold the confirmation of the touch operation and also receive desired touch operations on the delay region 12 after the elapse of the predetermined time t.

Furthermore, when new touch coordinates to be newly detected, besides the touch coordinates, before the predetermined time t passes are located in the normal region 13 within the operation region 11 of the touch panel 26, the portable terminal device 1 according to the embodiment confirms a touch operation using the new touch coordinates. As a result, the portable terminal device 1 according to the embodiment may quickly confirm a new touch operation on the normal region 13 while delaying the confirmation of the touch operation on the delay region 12.

Note that the respective components of each unit illustrated do not have to be physically configured as illustrated in the drawings. More specifically, specific configurations of distribution or integration of the respective units are not limited to those illustrated in the drawings, but all or a part thereof may be configured by functional or physical distribution or integration in an arbitrary unit according to various loads, use situations, and the like.

Furthermore, all of or any of various processing functions performed in each device may be executed on a central processing unit (CPU) (or a microcomputer such as a micro processing unit (MPU) and a micro controller unit (MCU)). Moreover, needless to say, all of or any of the various processing functions may be executed on a program to be analyzed and executed by the CPU (or the microcomputer such as the MPU and MCU) or on wired logic hardware.

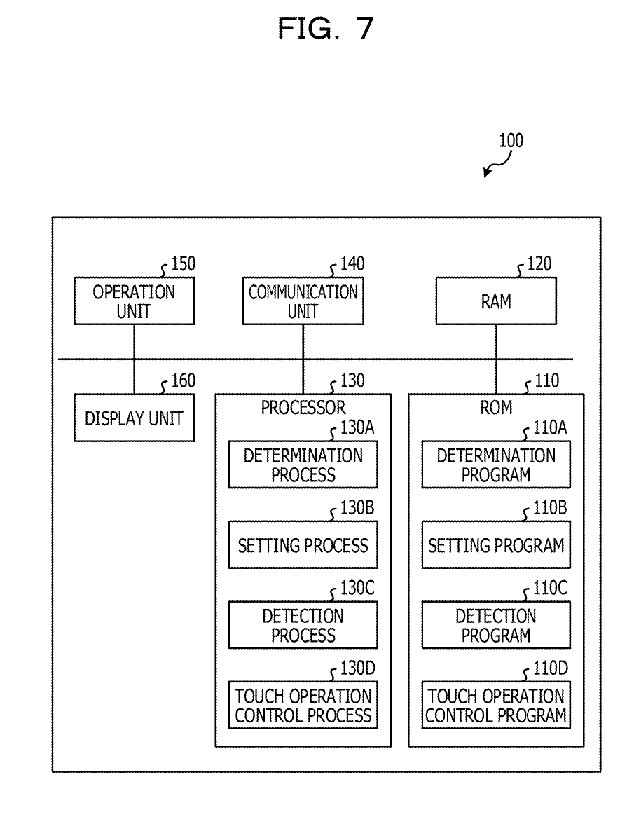

Meanwhile, the various kinds of processing described in the embodiment may be realized by executing a prepared program with an electronic device. Therefore, hereinafter, description is given of an example of an electronic device configured to execute programs having the same functions as those in the above embodiment. FIG. 7 is an explanatory diagram illustrating an electronic device configured to execute input control programs.

An electronic device 100 configured to execute the input control programs illustrated in FIG. 7 includes a ROM 110, a RAM 120, a processor 130, a communication unit 140, an operation unit 150, and a display unit 160. Note that the operation unit 150 is assumed to include a touch panel function to receive a touch operation by an operator.

The ROM 110 pre-stores input control programs having the same functions as those in the above embodiment. Note that the input control programs may be recorded in a recording medium that can be read by an unillustrated drive, instead of the ROM 110. Moreover, the recording medium may be, for example, a portable recording medium such as a CD-ROM, a DVD disk, a USB memory and an SD card, a semiconductor memory such as a flash memory, or the like. The input control programs include a determination program 110A, a setting program 1106, a detection program 110C, and a touch operation control program 110D, as illustrated in FIG. 7. Note that the programs 110A to 110D may be integrated or distributed as appropriate.

The processor 130 reads these programs 110A to 110D from the ROM 110 and executes the read programs. Then, the processor 130 causes the programs 110A to 110D to function as a determination process 130A, a setting process 130B, a detection process 130C, and a touch operation control process 130D, respectively, as illustrated in FIG. 7. These processes 130A to 130D correspond to the holding mode determination unit 41, delay region setting unit 42, touch coordinate detection unit 43, and touch operation control unit 44 illustrated in FIG. 3, respectively.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A portable terminal device comprising:
a touch panel configured to detect a touch operation by an operator;
a memory; and
a processor coupled to the memory, configured to determine a holding mode of the portable terminal device by the operator, and set a delay region, in which confirmation of the touch operation is delayed, in a predetermined region corresponding to the holding mode determined by the determination within an operation region of the touch panel.

2. The portable terminal device according to claim 1, wherein
the processor determines whether a hand holding the portable terminal device is the left hand or right hand, and sets the predetermined region located at the lower left corner of the operation region of the touch panel as the delay region when it is determined by the determination that the hand is the left hand and sets the predetermined region located at the lower right corner of the operation region of the touch panel as the delay region when it is determined by the determination that the hand is the right hand.

3. The portable terminal device according to claim 1, wherein
the processor detects coordinates of a contact position on the operation region of the touch panel when the touch operation is detected, waits for a predetermined time before confirming the touch operation using the coordinates when the coordinates detected by the detection are located in the delay region, and confirms the touch operation using the coordinates after the predetermined time has passed.

4. The portable terminal device according to claim 3, wherein
when other coordinates to be newly detected by the detection before the predetermined time passes are located in a region other than the delay region within the operation region of the touch panel, the processor confirms the touch operation using the other coordinates.

5. An input control method by a portable terminal device including a touch panel configured to receive a touch operation by an operator, comprising:
determining a holding mode of the portable terminal device by the operator; and
setting a delay region, in which confirmation of the touch operation is delayed, in a predetermined region corresponding to the determined holding mode within an operation region of the touch panel.

6. A machine readable medium storing a program that, when executed by a processor, causes the processor to perform operations comprising:
determining a holding mode of a portable terminal device by an operator, the portable terminal device including a touch panel configured to receive a touch operation by the operator; and
setting a delay region, in which confirmation of the touch operation is delayed, in a predetermined region corresponding to the determined holding mode within an operation region of the touch panel.
